(19) United States
(12) Patent Application Publication
(10) Pub. No.: US 2001/0045189 A1
(43) Pub. Date: Nov. 29, 2001

(54) Shrimp culture system

(76) Inventor: Roderick J. McNeil, Polson, MT (US)

Correspondence Address: DICKSTEIN SHAPIRO MORIN & OSHINSKY LLP, 2101 L Street NW, Washington, DC, 20037-1526, US

(21) Appl. No.: 09/751,933

(22) Filed: Jan. 2, 2001

Related U.S. Application Data
(60) Provisional application No. 60/173,803, filed on Dec. 30, 1999.

(51) Int. Cl. A01K 61/00

(52) U.S. Cl. 119/204

(57) ABSTRACT

One or more horizontal, sheet-like dividers are used to subdivide a water tank into multiple flow zones. The water flows downwardly through the zones in a controlled manner. Strips of high surface area material may be used to promote the photosynthetic production of oxygen. Since oxygen is produced in the water, a low water flow rate can be employed. The dividers are transparent to allow light to reach the areas where photosynthetic production is desired. The strips may also be used to promote natural feed production and biofiltration. The invention may be used to achieve a satisfactory feed-to-conversion ratio (FCR) with relatively low energy consumption and improved space utilization. In a preferred embodiment, oxygen and mineral content can be controlled by sensors and feedback loops. If desired, accumulated sediment may be filtered or digested and the treated water may be recycled.

### BACKGROUND OF THE INVENTION

1. Field of the Invention

The present invention relates to a system for rearing and/or culturing shrimp and other aquatic organisms. More particularly, the invention relates to a super-intensive culture system for pennaid shrimp. The present invention also relates to a multi-level tank apparatus for providing shelter, natural feed production and/or biofiltration. The present invention also relates to a system for recycling food waste and other waste material into a useable feed resource.

2. Discussion of the Related Art

In a typical system for culturing shrimp, the depth of the water is in the range of from 1.0 to 1.2 meters, and aeration is achieved by a low-energy, circulating pump apparatus. Air flow injectors and paddlewheels in the known systems generate water velocities in the range of from 50 to 180 centimeters per second (cm/sec). Typical stocking densities are in the range of from 20 to 150 post larvae per square meter (pl/m²), resulting in harvests in the range of from 0.2 to 2.0 kilograms per cubic meter of tank space (kg/m³). The relatively low efficiency of such deep water rearing tanks may become cost prohibitive, especially where such systems are installed indoors.

There is a need in the art for a multi-layer tank system that provides increased space utilization. In addition, there is a need in the art for a shrimp culture system that has low energy requirements. Moreover, there is a need in the art for an improved system for managing an aquatic culture apparatus.

### SUMMARY OF THE INVENTION

The present invention relates to a shrimp culture system in which one or more horizontal, sheet-like dividers subdivide a tank of water into multiple flow zones. In a preferred embodiment of the invention, high surface area material is used to promote the photosynthetic production of oxygen in the flow zones. The high surface area material may be in the form of fronds or strips attached to one or more of the dividers. The present invention makes it possible to rear shrimp indoors in a cost efficient manner, although the invention may also be applicable to outdoor systems.

According to one aspect of the invention, the dividers are stacked on top of each other, and they form gaps with the walls of the tank, such that the water flows upwardly through the flow zones in a zigzag fashion. The gaps provide flow paths upwardly from one flow zone to the next through the tank. If desired, a pump may be used to cause the water to flow downwardly through the tank.

According to another aspect of the invention, a multi-level tank system is used to provide shelter, natural feed production and/or biofiltration, in the context of rearing shrimp and other aquatic organisms. The multiple levels are formed by one or more horizontally stacked dividers, and high surface area material may be attached to at least one of the dividers. The high surface area material may be in the form of buoyant and non-buoyant strips, attached to the top and the bottom of the divider, respectively. In a preferred embodiment of the invention, the divider is transparent so that photosynthesis and/or biofiltration can occur underneath it. The light source may be submerged so that it also serves as a source of heat for the water.

The present invention also relates to an improved method of operating an aquatic culture apparatus. According to this aspect of the invention, high surface area material is used to promote the photosynthetic production of oxygen, and water velocity is controlled to manage the oxygen content in the water and to achieve the desired feed conversion ratio (FCR). In a preferred embodiment of the invention, the water velocity is determined by the vertical spacing between the dividers and the rate at which additional water is injected into the tank.

According to another aspect of the invention, the pump that injects the water into the tank is reversible for sediment removal. The removed sediment may be filtered or digested, and then the treated water may be returned to the tank. If desired, a bioreactor or fermentor may be used to turn the sediment into a recycled feed resource.

Studies of shrimp habitat have shown a marked preference for relatively low velocity water flows (i.e., less than 50 to 180 cm/sec). Shrimp have been found to be most effective at feed recovery when the water flow velocity is less than 4 cm/sec. Additionally, it has been found that shrimp prefer to remain within 25 cm of the bottom at all times. It is not known whether this is an orientation issue or a mechanism to improve predator avoidance. The present invention takes advantage of these findings by subdividing the height of the water column and reducing the flow velocity through the apparatus. Thus, according to one aspect of the invention, increased stocking densities (e.g., in the range of from 500 to 750 pl/m³, and more preferably from 500 to 1,000 pl/m³ or more) can be achieved without increasing energy or relative feed requirements.

According to another aspect of the invention, improved performance is achieved by providing a culture tank with multiple levels. Each level may be in the range of from 15 to 50 cm deep. The levels are separated by sheet-like horizontal dividers. The dividers may be transparent to optical radiation in the range of from 370 to 800 nanometers (nm). Strips or fronds of flexible high surface area material are attached to the dividers to provide shelter and natural feed production as well as environmental biofiltration. If desired, the strips attached to the tops of the dividers may be buoyant, to suspend the dividers horizontally in the water column. The material attached to the bottom of the sheet-like divider has a specific gravity above one, such that it helps to offset the buoyancy of the buoyant material. In a preferred embodiment of the invention, the positive and negative buoyancies of the two materials offset one another exactly. The present invention should not be limited, however, to the preferred embodiments shown and described in detail herein.

In a preferred embodiment of the invention, a tank that is stocked with up to 1,000 pl/m³ may be used to produce 17 kilograms of shrimp per m³ of tank space during each production cycle. The tank may have an FCR that is consistently below 1.2. Survival may be in the range of from 80 to 85%, and the average size of the cultured shrimp may be greater than or equal to 17.5 grams in less than 130 days.

In a preferred embodiment of the invention, the average rate of flow of water through the shrimp rearing portions of the apparatus (where the shrimp are located between the dividers) is in the range of from 2 to 40 millimeters per second (mm/sec.), and more preferably in the range of from 4 to 20 mm/sec.

These and other features and advantages of the invention will become apparent from the following detailed description of preferred embodiments.

### BRIEF DESCRIPTION OF THE DRAWINGS

FIG. 1 is a schematic top view of a system for rearing shrimp, constructed in accordance with one embodiment of the present invention.

FIG. 2 is a cross-sectional view of the multi-layer aquatic tank for the system of FIG. 1, taken along line 2-2.

FIG. 3 shows the relationships between feed conversion ratio (FCR) and water velocity for an aquatic system operated with and without high surface area material.

FIG. 4 is a cross-sectional view of a two-layer aquatic tank constructed in accordance with another embodiment of the present invention.

FIG. 5 is a partially broken-away cross sectional view of a portion of the tank of FIG. 2.

### DETAILED DESCRIPTION OF PREFERRED EMBODIMENTS

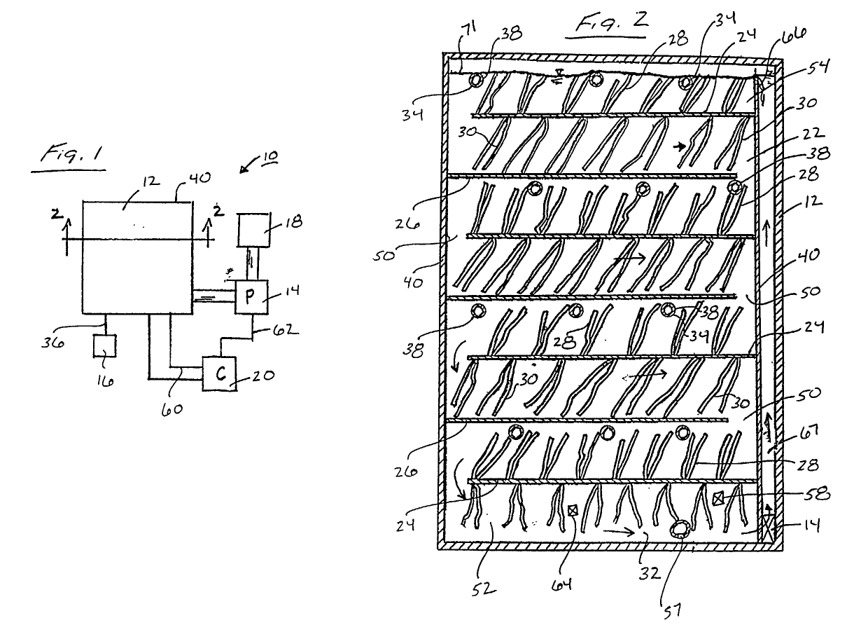

Referring now to the drawings, where like reference numerals designate like elements, there is shown in FIG. 1 a system 10 for rearing shrimp. The system 10 has a multi-layer tank 12, a reversible pump 14 for circulating water through the tank 12, a power source 16 for energizing lights within the tank 12, a bioreactor unit 18 for digesting waste material, and an operational control unit 20 (described in more detail below).

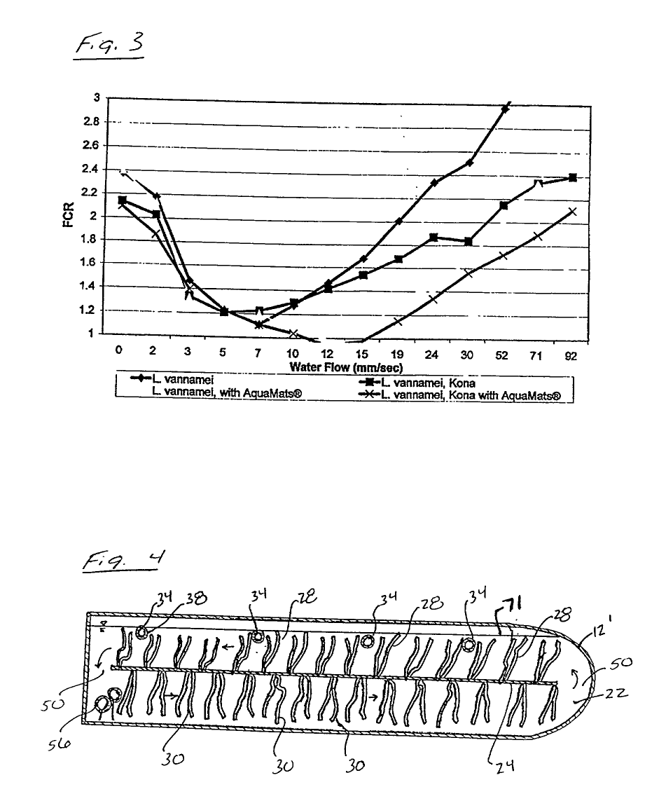

As shown in FIG. 2, the tank 12, which may be formed of plastic or other suitable materials, is filled with water 22. The water-containing portion of the tank 12 is horizontally subdivided into multiple levels (flow zones) by sheet-like dividers 24,26. Some of the shrimp larvae (not shown) are supported on the dividers 24, 26 and some are located in the flow zones between the dividers 24,26. The dividers 24,26 are transparent to optical radiation in the range of from 370 to 800 nm, for reasons discussed in more detail below. Flexible strips 28, 30 of high surface area material are attached to some of the dividers 24 to provide shelter for the shrimp larvae. In the illustrated embodiment, the high surface area material 28, 30 also provides natural feed production and environmental biofiltration.

In the illustrated embodiment, the strips 28 attached to the tops of the dividers 24 are buoyant, to suspend the dividers 24 horizontally in the water column 22. The strips 30 attached to the bottoms of the dividers 24 have a specific gravity greater than one, to offset the buoyancy of the top-attached buoyant material 28. If desired, the positive and negative buoyancies of the two materials 28, 30 offset one another. Offsetting the buoyancy of between the weight of the sheet 24, the positive buoyancy of the fronds 28 on top and the negative buoyancy fronds 30 on the bottom, eliminates having to restrain the plate-shaped divider 24 from floating. The divider 24 may simply rest on shelves at the side walls 40, making removal of the dividers 24, 26 for cleaning less complicated and more efficient.

If desired, the strips (or fronds) 28, 30 are stapled to every other divider 24. Folded-over portions of the strips 28, 30 can be connected to the dividers 24 by surgical stainless steel staples or by other suitable mechanisms. The strips 28, 30 are sized to provide 1 to 2 cm clearance off the bottom, so as to allow for through-passage of the detritus formed in the system. The total amount of flexible high surface area material 28, 30 to be attached to the dividers 24 may depend on the stocking density, but the amount of material 28, 30 should be maximized to minimize feed costs and reduce external biofiltration requirements. Thus, where the dividers 24, 26 are vertically spaced 25 cm apart and the flexible material 28, 30 consists of 2.5 cm strips 50 cm long (folded in half for stapling), it is possible to deploy as much as 12.3 square meters of high surface area material 28, 30 per square meter of divider 24, 26. In an exemplary arrangement, the strips 28, 30 are located at 10 cm intervals in rows spaced 12.5 cm apart.

The buoyant and non-buoyant strips 28, 30 may be constructed of multi-layer materials of the type described in U.S. patent application Ser. No. 09/134,735, filed Aug. 14, 1998. The entire disclosure of U.S. patent application Ser. No. 09/134,735 is incorporated herein by reference. If desired, the strips 28, 30 may be formed of the same material as is used to produce AquaMatsg brand aquaculture products marketed by Meridian Aquatic Technology, L.L.C., Calverton, Md.

The strips 30 attached to the bottoms of the dividers 24 may be stapled in rows that are offset relative to the rows (28) on top of the divider 24 to maximize the amount of light that penetrates to the bottom 32 of the tank 12. In the illustrated embodiment, it is neither desirable nor necessary that the same amount of light reach the top-attached fronds 28 as reaches the bottom-attached fronds 30. The primary function of the bottom-attached fronds 30 is bacteriological biofiltration. The requirement is for light in the 600 to 800 nm range to conduct bacterial photosynthesis. The primary function of the top-attached fronds 28 is to support plant photosynthesis, with its wavelength maxima in the 380 to 450 nm range.

It should be noted that only every other divider 24 needs to have high surface area material 28, 30 attached to it. Every divider 24, 26 becomes the bottom for the water segment above it, thereby eliminating the need to attach material 28, 30 to each level. This further decreases the manufacturing cost of the system 10.

The optical transparency of the dividers 24, 26 allows photosynthetic periphyton growth activity to take place on the fronds 28, 30 (especially on the top-attached fronds 28). In the illustrated embodiment, an artificial (or natural) light source 34 of greater than 2,500 lux is used to continuously illuminate the fronds 28, 30 to thereby supplement the production of oxygen in the tank 12. By using the photosynthetic process to increase oxygen production, the flow rate of water through the system 10, 12 may be reduced which improves the available FCR.

The light source 34 may be formed of phosphor fluorescent lighting units sealed in quartz tubes 38 that extend horizontally through the tank 12 between the dividers 24, 26. As alternatives to quartz, the tubes 38 could be made of polyethylene, Teflon, certain polycarbonates or other suitable materials that pass the intended wavelengths of radiation. The tubes 38 penetrate the sidewalls 40 of the tank 12. Consequently, they allow for easy extraction and replacement of burned out bulbs 34. In addition, by locating retainers (not shown) over the ends of the tubes 38, the tubes 38 restrain the sidewalls of the tank 12 and keep those walls 40 from bulging outwardly. In other words, the tubes 38 operate as tension elements to hold the tank 12 together.

Electrical energy for the light source 34 is supplied by the power source 16 (FIG. 1) via suitable electrical connectors 36. The intensity of light in the 450 nm wavelength range should be in excess of 6,000 lux, but less than 20,000 lux to prevent photo-bleaching of photosynthetic pigments. The fluorescent lights 34 are placed through the tank 12 at 50 to 60 cm intervals, to provide uniform light intensity throughout the tank 12. Light intensity is maintained at 6,000 lux or more at 25 cm from the individual bulbs 34 to maximize photosynthesis.

Since the tubes 38 are located below the water line, the flow of water 22 over the tubes 38 dissipates heat from the lamps 34, such that the energy (16) that powers the lamps 34 also contributes to the heating of the water 22. The light source 34 may provide over 50% of the heat needed to maintain the water 22 in the tank 12 at 29 C°. If desired, the walls 40 of the tank 12 are insulated with 5 cm of closed cell foam to provide heat retention in northern climates. By allowing the rearing of shrimp indoors, the shrimp culture can be maintained in the described tank culture system regardless of the surrounding environment. By utilizing flow velocities sufficiently low that laminar flow is not disrupted, oxygen in solution in the water 22 is not lost due to cavitational disruption of gas saturation tension. Thus, a low flow velocity can be employed which improves the efficiency of the photosynthetic process.

As shown in FIG. 2, the dividers 24, 26 do not extend horizontally all the way to the opposite walls 40 of the tank 12. Instead, the dividers 24, 26 leave alternating flow gaps 50 adjacent the walls 40, allowing free circulation from the top zone 54 to the bottom zone 52 of the tank 12. Recirculated and/or added water may be injected into the top zone 54 on top of the top-most divider 24. The use of a narrow slot 57A (operated by the pump 14) beneath the lowest divider 24, allows for the precise control of water through-flow at about 10 percent the cost of known circulation systems. The flow velocity generated by the pump 14 can be controlled by a feedback loop in the control unit 20 as a function of oxygen tension in the water 22.

As the water 22 flows through the top zone 54 of the tank 12, shrimp metabolism consumes oxygen, such that the oxygen tension in the water 22 falls. As the water 22 flows downward in a zigzag fashion through the gaps 50, shrimp metabolism withdraws even more oxygen. An oxygen sensor 58 monitors the oxygen tension at preset time intervals. The illustrated sensor 58 is operatively connected to the control unit 20 by a suitable signal line 60. When the oxygen tension falls below a preset alarm level, a signal may be sent (62) to the pump 14 to increase the flow velocity to raise the average oxygen tension in the water 22. When the oxygen tension becomes greater than a predetermined threshold, the control unit 20 may send a signal to the pump 14 to reduce the flow velocity, to reduce energy usage and to operate at a flow velocity that achieves a greater FCR. In a preferred embodiment of the invention, the circuit 58, 60, 20, 62 is set up such that if the oxygen tension does not raise above the alarm level within 10 minutes after increasing the flow, a solenoid valve (not illustrated) opens to allow pure oxygen flow to the injector 56, on the bottom of the spillway, to further increase the oxygen partial pressure.

If desired, the same tube 56 that is used for the injector/oxygen input may be used to selectively siphon sediment 59 (FIG. 5) out of the bottom zone 52 under the control of a separate reversible pump and/or a suitable valve arrangement (not shown). The corner angle at the back of the tank 12 produces an eddy, which causes the sediment to precipitate out of suspension immediately below the sediment draw tube 56. By changing the angle of incidence of the flow injector slot 57 relative to the bottom 52, it is possible to alter the size and capacity of the settlement zone. Once sufficient settlement has taken place, the separate pump is operated in the siphoning direction, and the flow is passed into the bioreactor 18.

When the pump is operated in the reverse (siphoning) mode, the accumulated detritus is sucked out of the lower level 52 and passed to the bioreactor (e.g., a separate fermentor tank 18). The suspended detritus (feed waste, fecal material and other waste material) is continually agitated in the tank 18 with air for 4 to 6 days to complete the oxidation of the organic matter to a form that is useable as a feed resource by the shrimp. At the next cleaning, the digested detritus is pumped back into the tank 12 after the new load of detritus has been removed. This process can be easily controlled by manual manipulation and visual observation as it may only need to be performed for about 5 minutes every two weeks.

In an alternative embodiment, a separate sediment siphon tube (separate from the injector tube 56) is located 5 cm off the bottom 32 of the tank 12. The diameter of the siphon tube (not shown) may be about 5 cm, and it may have a 1 cm wide slot along its length (for essentially the full width of the tank 12). Instead of sending the sediment-entrained water to the bioreactor 18, the system 10 may be arranged to send the water through a depth filter (not shown) and then back into the tank 12.

Supplemental oxygen for the tank 12 may be introduced in more than one way. In a first mode, air or oxygen is introduced into the fluidic flow stream of the injector 56 such that the oxygen is distributed throughout the tank 12 by displacement. Another approach is to inject hydrogen peroxide into the tank 12, at a disassociation rate equivalent to the rate of oxygen tension reduction in the cycling of fluids through the system 10. The use of hydrogen peroxide has multiple benefits. It provides complete oxidation of organic matter in the system and it does not require a pumping system for the delivery of compressed gasses to the injection flow stream (56). The illustrated system 10 cannot tolerate residual amounts of hydrogen peroxide, however, as it will tend to kill the bacteria in the flow zones, which stops the biofiltration process.

Thus, in a preferred embodiment, a continuous amount of hydrogen peroxide is bled into the water 22 to maintain a peroxide residual of less than 0.5 ppm. If desired, the flow rate and dilution of hydrogen peroxide in the system can be controlled by the dissolved oxygen probe feedback loop 58, 20, 62. Further, the illustrated system 10 cannot depend on peroxide to provide any significant amount of dissolved oxygen. In a preferred embodiment, air is injected with the peroxide during the first 12 weeks of the culture process, and then the operation is switched to pure oxygen for the last 6 to 8 weeks of culture with little or no peroxide addition.

Feed is added to the top zone 54 of the tank 12 (i.e., above the upper-most divider 24). The added feed (not shown) moves gradually down through the tank 12 by flow displacement and gravity while being swept by the water current across all levels of the tank 12, such that the feed is presented to all of the cultured species in the tank 12 for maximum feed intake. In other words, the feed is introduced at the top 54 and then it flows down across all of the decks 24,26 to allow full access to the feed by the shrimp. The downward motion of the feed through the tank 12 may also help draw the shrimp up from the lower decls to increase their interaction with the feed earlier. The food which is not eaten by the shrimp directly is broken down by solubilization and bacterial action, releasing nutrients to the water column. The bacterial and algal communities inhabiting the high surface area fronds 28, 30 adsorb the nutrients from solution and convert the material to a biomass which can be utilized as a feed resource by shrimp and other demersal grazers.

It has been determined that some minerals in the water 22 become depleted during the shrimp culture cycle. They have been found to become depleted in a fixed ratio relative to calcium. In a preferred embodiment, a dedicated selective ion electrode 64 is used to monitor calcium concentration in the water 22. The electrode 64 provides the input to a forward control feedback loop, via the control unit 20, for the addition of a pre-mix containing all the inorganics found to become depleted in a fixed ratio relative to calcium. These elements include iodine, strontium, zinc, calcium, silicon and manganese.

By designing the tank 12 with a series of dividers 24, 26, at fixed vertical intervals, a culture tank 12 of almost any height can be built while the production efficiency, based on volume, remains essentially constant. Any decrease in efficiency as the number of decks 24, 26 increases may be due mainly to the shrimp redistributing themselves on different levels to take advantage of feed introduction locations and oxygen gradients. The multilayer approach illustrated in FIGS. 1 and 2 allows the indefinite expansion of the culture tank 12 in all three dimensions while maintaining the desired volumetric stocking efficiency.

A return spillway 66 at the top of the tank 12, may be used with the pump 14 (which may be a small, submerged draw pump) to move the fluids and control flow velocity in the tank 12. Based on the flow velocity of the pump 14, the flow of the water 22 in the tank 12 (represented by arrows in FIG. 2) comes into equilibrium with the water 67 in the spillway 66. The water at the top 52 of the tank 12 moves downward around the dividers 24, 26 The hydrostatic head on the pump 14 may be very low, as it is only necessary to push the water 22 a short distance over the headwall to create the necessary flow displacement over and out of the spillway 66.

If desired, the tank 12 can be sealed to reduce or minimize evaporative losses, such that very few water additions to the system 10 are necessary. If desired, a layer of plastic beads (not shown) can be floated on the top surface 71 of the water 22 to reduce evaporation. The evaporative control beads may be of the type that are used in high temperature oil baths to keep hot oil from splattering on surrounding surfaces.

### EXAMPLES

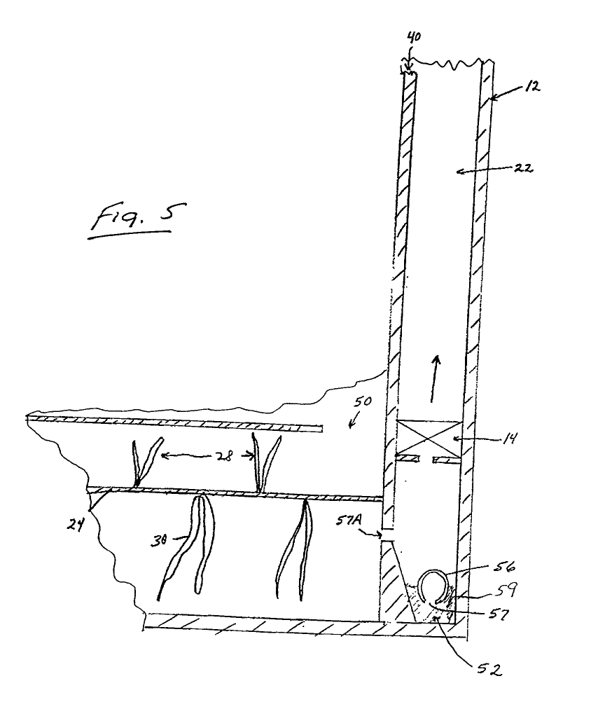

A single-tier system (FIG. 4) with a tank 12′ and a divider 24 at the 25 cm level was deployed using 2.5 square meters of material 28, 30 on either side. Spacing between rows was 20 cm and spacing between fronds 28, 30 was 12 cm. The material 28, 30 was cut to a length of 46 cm (23 cm when folded and stapled). Flow velocity was maintained at 2 cm/sec and compressed air was injected for the first 12 weeks. Thereafter, pure oxygen was used for injection. Stocking density was 550 pl/m³. The total volume of the tank 12′ was 2.0 cubic meters. Seawater 22 was synthetic, produced from Aquarium Systems Reef Crystals. Light was provided by three 110-watt VHO actinic fluorescent lamps 1.22 meters in length. Sediment was removed from the tank 12′ once every two weeks for the first 12 weeks and once per week thereafter. Feed was Rangen 30% with 2% squid addition. Average growth was 0.83 grams/week and final harvest was 8.1 kilos/cubic meter of solution. The energy costs of production per kilogram of shrimp was $0.21 (at 4.6 cents per kW). The fully loaded cost with feed was $1.10 per kilogram. The overall FCR (feed-to-conversion ratio) was 1.68.

Four additional production cycles (Cycles I through IV) were conducted as discussed below. In each cycle, the nursery period was 45 days, and the growout took place in a 3 m³ tank. Cycle I had sludge removal for the first time after 8 and 12 weeks and no hydrogen peroxide was used at all. Growth was terminated once the weekly growth average fell below 1.00 grams/week. Oxygen was used after week 10. Cycle I utilized an open strain of L. vannamei from Harlingen, Tex. Cycle II was allowed to go as long as possible to determine growth rates with the passage of time and no peroxide was used at all. Sludge collection was at weeks 8, 12, 14, 16-18, 20 and 22 weeks. Oxygen was used after week 12. Cycles II through IV utilized the Kona strain of L. vannamei. Cycle III had sludge removed at 6, 8, 10, 12-15 and 17 weeks with no reuse of sludge. Peroxide additions were continuous at 1.0 ppm from weeks 2-12. Oxygen injection was started at 12 weeks. Calcium and the other minerals listed above were added to the system weekly after week 12. Light intensity was increased from 6,000 lux in cycles I and II to 10,600 lux in cycles III and IV. Cycle IV utilized the reintroduction of digested waste, with waste collected at 8, 10, 12, 14, 16 and 17 weeks. Peroxide was maintained at 0.5 ppm and all other conditions were identical to cycle three. The results from cycle IV were considered excellent and are believed to be the highest continuous production figures ever produced in the Western Hemisphere.

Other data concerning Cycles I through IV are shown below in Table 1. The results shown in Table 1 were obtained in a 3 m³ tank with 2 levels, generally like the tank 12′ shown in FIG. 4. The illumination was at 7,000 lux, 6,400 color temp., and 400 watts.

| | Cycle Number | | | | |
|---|---|---|---|---|---|
| | 1 | 2 | 3 | 4 | Avg. |
| Stocking Density | 600 | 550 | 500 | 500 | 538 |
| (Pls/m²) | | | | | |
| FCR | 2.78 | 2.87 | 1.71 | 1.14 | 2.13 |
| Total Survival (%) | 67% | 64% | 82% | 85% | 78% |
| Cycle Time, nursery + | 90 | 181 | 137 | 128 | 134 |
| growout (days) | | | | | |
| Avg. Final Size (g) | 15.2 | 23.6 | 17.9 | 17.6 | 18.6 |
| C.V. In Size | 14% | 12% | 10% | 10% | 12% |
| Avg. Growth (g/week) | 1.18 | 0.91 | 0.91 | 0.97 | 0.99 |
| # of Cycles per Year | 7.6 | 2.6 | 3.8 | 4.3 | 4.6 |
| Production per Harvest | 6.1 | 8.3 | 7.3 | 7.4 | 7.3 |
| (Kg/m²) | | | | | |
| Annual Yield | 46.4 | 21.6 | 27.7 | 31.8 | 33.6 |
| (Kg/m²/year) | | | | | |

FIG. 3 shows the relationships between FCR and water flow velocity for a system generally like the one shown in FIGS. 2 and 4, with strips formed of AquaMats® brand high surface area material arrayed at a density of 3.7 m²/m³, and with a shrimp stocking density of 500 pl/m³.

The entire disclosure of U.S. Provisional Patent Application No. 60/173,803, filed Dec. 30, 1999, is incorporated herein by reference.

The above descriptions and drawings are only illustrative of preferred embodiments which achieve the features and advantages of the present invention, and it is not intended that the present invention be limited thereto. Any modification of the present invention which comes within the spirit and scope of the following claims is considered part of the present invention.

What is claimed as new and desired to be protected by Letters Patent of the United States is:

1. A shrimp culture system, comprising:
a water tank;
a divider for dividing said tank into horizontal flow zones; and
high surface area material for promoting photosynthetic production of oxygen in said tank.

2. The system of claim 1, wherein said divider is in the form of a sheet that extends horizontally in said tank.

3. The system of claim 2, wherein said divider and said tank form a gap for providing a flow path from one of said flow zones to another of said flow zones.

4. The system of claim 3, further comprising a pump for flowing water downwardly through said tank.

5. A multi-level tank system for providing shelter, natural feed production and/or biofiltration, said system comprising:
a water tank;
sheet-like horizontal dividers located in said tank; and
high surface area material attached to at least one of said sheet-like dividers.

6. The tank system of claim 5, wherein said high surface area material includes buoyant and non-buoyant strips.

7. The tank system of claim 5, wherein at least one of said dividers is transparent to allow optical radiation to reach said high surface area material.

8. The tank system of claim 7, further comprising a light source for generating said optical radiation, said light source being submerged in said water tank.

9. A method of operating an aquatic culture apparatus, said method comprising the steps of:
using high surface area material to promote photosynthetic production of oxygen, said high surface area material being located in said aquatic culture apparatus; and
controlling the velocity of water flowing through said aquatic culture apparatus.

10. The method of claim 9, further comprising the step of flowing said water through multi-layer flexible fronds.

11. The method of claim 10, further comprising the step of using a pump to add water to the top of said aquatic culture apparatus.

12. The method of claim 11, further comprising the step of removing sediment from said aquatic culture apparatus.

13. The method of claim 12, further comprising the step of digesting said sediment to produce a useable feed resource.

14. The method of claim 9, further comprising the step of sensing the oxygen content in said aquatic culture apparatus.

15. The method of claim 9, further comprising the step of sensing the mineral content in said aquatic culture apparatus.

16. The method of claim 9, further comprising the step of rearing shrimp in said aquatic culture apparatus.

17. The method of claim 16, further comprising the step of locating said aquatic culture apparatus indoors.

18. The method of claim 9, wherein the average water velocity in said apparatus is less than 3 centimeters per second.

19. The method of claim 18, wherein horizontally-extending dividers are provided in said apparatus, the vertical spacing between said dividers being not less than 15 centimeters and not greater than 50 centimeters.

20. The method of claim 19, further comprising the step of stocking said apparatus with greater than 500 post larvae per cubic meter.

21. The method of claim 20, further comprising the step of maintaining an average feed-to-conversion ratio of no more than 1.4.
